(19) United States
(12) Patent Application Publication
(10) Pub. No.: US 2014/0375017 A1
(43) Pub. Date: Dec. 25, 2014

(54) Device for introducing at least one lengthwise extended technical functional part into a frame section of a vehicle

(71) Applicant: Derby Cycle Werke GmbH, Cloppenburg (DE)

(72) Inventor: Mario Pöss, Stuttgart (DE)

(21) Appl. No.: 14/308,023

(22) Filed: Jun. 18, 2014

(30) Foreign Application Priority Data
Jun. 19, 2013 (DE) 20 2013 005 555.3

(51) Int. Cl. B62K 19/30

(52) U.S. Cl. CPC B62K 19/30
USPC 280/281.1

(57) ABSTRACT

In a device for introducing at least one lengthwise extended technical functional part in a frame section of a vehicle, in particular a bicycle, including an insert section that is to be abutted against an opening in the frame section, through which the functional part can be guided, it is provided that at least one lengthwise extended receiving section for the functional part be attached to the insert section. This device makes it possible to hold or guide the technical functional part during its introduction into a frame section.

### BACKGROUND OF THE INVENTION

1. Field of the Invention

The invention relates to a device for introducing at least one lengthwise extended technical functional part into a frame section of a vehicle, in particular a bicycle, encompassing an insert section that is to be abutted against an opening in the frame section, and through which the functional part can be guided.

2. Brief Discussion of the Related Art

Vehicles with frame sections, i.e., with frames, can be two- and multi-track vehicles, bicycles, motorcycles and mopeds along with four-wheeled, muscle-powered vehicles. Such vehicles have technical devices, such as switches and/or lights, and the latter are connected both with each other and other components with lengthwise extended technical functional parts. The lengthwise extended functional parts can here be Bowden cables for brakes or switches or even cables and lights.

It has already been suggested in prior art that such functional parts be integrated into frames, where they are protected against dust and contamination. Since the technical functional parts must connect components outside the frame with each other, for example the handles of a brake, the functional parts must be introduced into a frame and guided out of the latter.

Openings in the frame sections through which the functional parts can be introduced have already been proposed in prior art. An insert section, for example an O-ring, can here be provided, through which the functional part is guided. The insert section is intended to seal the entrance of the functional part inside the frame, so that dirt and moisture do not get inside the frame.

If the vehicle is a bicycle, the handlebar area encompasses a series of technical functional parts, specifically Bowden cables for brakes and for switching components. While these are routinely introduced into the steering head of the bicycle frame, the problem is that the steer tube is located in the steering head of the bicycle frame. Bowden cables introduced there can rub against the steer tube, becoming damaged in the process, and also influence the steering of the bicycle.

### BRIEF SUMMARY OF THE INVENTION

Therefore, the object of the invention is to describe a device of the type mentioned at the outset that makes it possible to hold or guide the technical functional part during its introduction into a frame section.

This object is achieved according to the invention by attaching at least one lengthwise extended receiving section for the functional part to the insert section.

The device according to the invention exhibits an insert section similar to that in prior art. In the surface of the frame section, it is allocated to an opening in the frame section, wherein the technical functional part can pass through the insert section and enter into the frame section. However, according to the invention, the technical functional part then does not enter into a free space within the frame section, but rather into the receiving section. According to the invention, the latter is attached to the insert section and holds the functional part. This advantageously makes it possible to guide the functional part, for example past a steer tube. Functional parts guided into the frame then do not come into contact with other components inside the frame, thus remaining undamaged and durable for a long time.

A first further development of the invention provides that the insert section and receiving section constitute a one-piece molded part, for example made out of plastic. This yields a simple design for this molded part, which can be fabricated at a low cost.

A next further development of the invention provides that the insert section and receiving section have several channels through which functional parts, such as Bowden cables, are guided. Each functional part can be provided with a channel to accommodate the latter. As a result, the lengthwise extended receiving section also has lengthwise extended channels, for example which can be arranged parallel to each other when several functional parts are to be guided in the same direction. The functional parts are separated from each other, and each enveloped by segments of the receiving section, so that they cannot come into contact with other components inside the frame section.

A next further development of the invention provides that the receiving section has areas guided out of the frame section. The functional parts are introduced into the receiving section via the insert section. They pass through the latter, and can also be removed along with the receiving section from the frame section into which they were introduced. For example, this frame section can be a steering head to which other frame sections are attached, for example a top tube and/or a down tube, via couplings or welding or in some other way. The functional parts are to be inserted into the open ends of these tubes. For this purpose, the receiving section can protrude from the first frame section, i.e., the steering head, and is then introduced a ways into a top tube, for example. As a result, the functional parts can be guided beyond the attachment areas of two frame sections. Under certain conditions, these attachment areas can exhibit edges or ridges, which can rub against functional parts. The device according to the invention allows them to bypass these areas.

To further develop the invention, it is provided that the insert section be plate-like, wherein its extension is larger than the width of the opening in the frame. While the device is being pushed into an opening in the frame, the insert section can rest on the outer surface of the frame. It thereby flatly covers the opening in the frame. The insert section can incorporate an attachment means for securing the insert section to the frame, for example an opening through which can pass a screw, which is tightened into a corresponding thread in the frame section.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view depicting sections of a bicycle frame with inserted front wheel fork;

FIG. 2 is a side view of the bicycle frame according to FIG. 1;

FIG. 3 is a partially cut side view of the bicycle frame according to FIG. 1, and

FIG. 4 is a sectional view of the frame according to FIG. 1.

### DETAILED DISCUSSION OF THE PREFERRED EMBODIMENTS

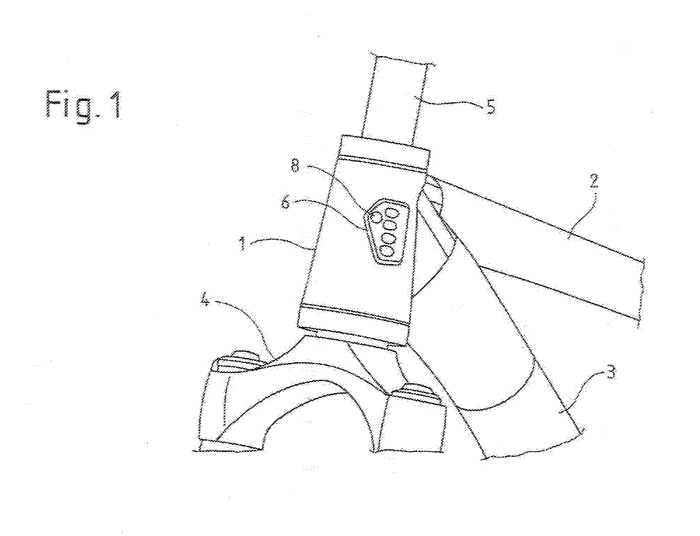

The bicycle frame on FIG. 1 is shown with its steering head 1, a top tube 2 and a down tube 3. The steering head 1 incorporates a fork 4 with a steer tube 5.

An insert section 6 of the device according to the invention is situated on the surface of the steering head 1 in order to introduce technical functional parts 7 into the steering head 1.

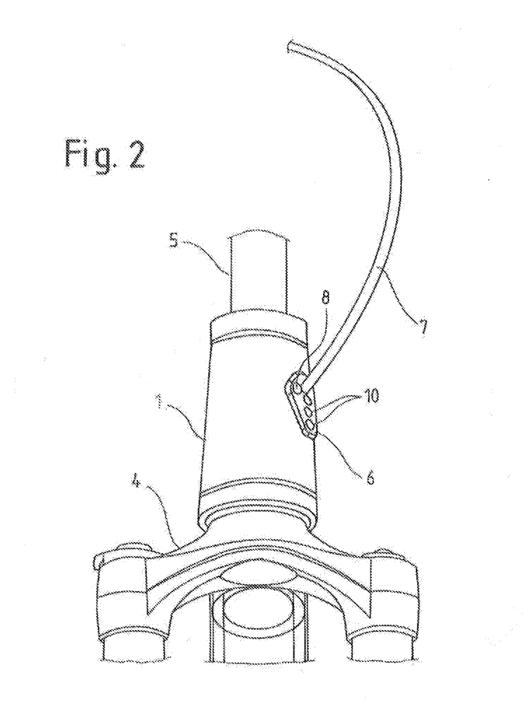

As depicted on FIG. 2, a functional part 7, specifically a Bowden cable, is introduced through the insert section 6. The functional part 7 is guided via the insert section 6 into the steering head 1. The insert section 6 is here fixed to the steering head 1 with a screw 8.

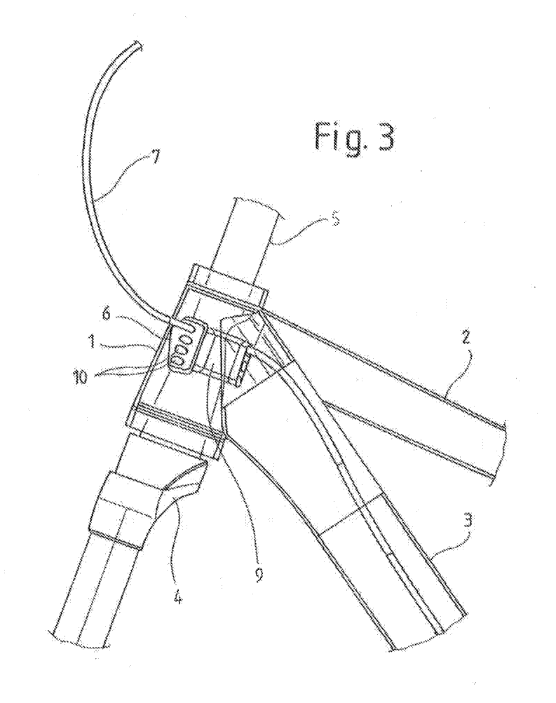

As depicted on FIG. 3, the functional part 7 is routed through the steering head 1 and into the down tube 3. The functional part 7 is here guided through a receiving section 9, wherein this receiving section 9 is attached to the insert section 6. The insert section 6 and receiving section 9 have four channels 10 for receiving functional parts 7.

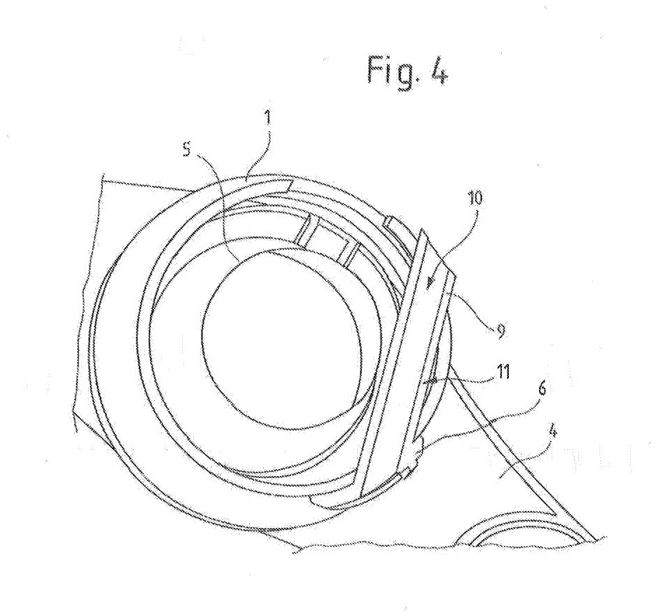

FIG. 4 shows the one-piece molded part 11 comprised of the insert section 6 and receiving section 9. A channel 10 is depicted in cross section. As illustrated on FIG. 4, the receiving section 9 guides technical functional parts 7 past the steer tube 5. The functional parts 7 are mechanically shielded from the steer tube 5 in the channels 10.

All features described in the above specification and mentioned in the claims can be combined with the features in the independent claim however desired. Therefore, the disclosure of the invention is not confined to the described or claimed feature combinations; rather, all reasonable feature combinations within the framework of the invention must be regarded as disclosed.

1. A device for introducing at least one lengthwise extended technical functional part in a frame section of a vehicle, in particular a bicycle, comprising an insert section that is to be abutted against an opening in the frame section, and through which the functional part can be guided,
wherein at least one lengthwise extended receiving section for the functional part is attached to the insert section.

2. The device according to claim 1, wherein the insert section and receiving section constitute a one-piece molded part.

3. The device according to claim 2, wherein the molded part is made out of plastic.

4. The device according to claim 1, wherein the insert section and receiving section have several channels though which to guide functional parts, such as Bowden cables.

5. The device according to claim 1, wherein the receiving section has areas guided out of the frame section.

6. The device according to claim 1, wherein the insert section is plate-like in design, wherein its extension is larger than the width of the opening in the frame section.

7. The device according to claim 6, wherein the plate-like insert section has allocated to it at least one attachment means for securing the insert section to the frame section.

8. The device according to claim 1, wherein the insert section can be made to abut against a steering head of a bicycle frame.
